(19) United States
(12) Patent Application Publication
(10) Pub. No.: US 2025/0193986 A1
(43) Pub. Date: Jun. 12, 2025

(54) POWER OVER ETHERNET (POE++) LIGHT EMITTING DIODE (LED) DRIVER AND A FIVE-CHANNEL CONTROLLER ASSEMBLY

(71) Applicant: SGi Technology Group Limited, Oakville (CA)

(72) Inventor: Shabir Gova, Oakville (CA)

(21) Appl. No.: 18/936,558

(22) Filed: Nov. 4, 2024

(30) Foreign Application Priority Data
Dec. 7, 2023 (IN) 202341083436

(51) Int. Cl. H05B 47/185; H05B 45/34; H05B 45/345; H05B 45/37; H05B 47/25

(52) U.S. Cl. CPC H05B 47/187; H05B 45/34; H05B 45/345; H05B 45/37; H05B 47/25

(57) ABSTRACT

The invention relates to a Power over Ethernet (PoE++) LED driver and five-channel controller assembly. The assembly (100) comprises a PoE++ input passthrough port (101) for powering and controlling PoE+ compatible devices, five output channels (102) for providing constant voltage and constant current outputs, making it ideal for diverse lighting applications. The assembly (100) is designed with waterproof and dustproof attributes (104), achieving an Ingress Protection (IP) rating, enabling outdoor installations across a wide temperature range. The assembly (100) comprises an integrated power conversion controller (104) with built-in protection mechanisms, allowing it to manage overloading faults. The assembly's (100) compact form factor suits installations with space limitations. The assembly (100) smoothly integrates with home automation systems through custom firmware drivers and features built-in lighting control functions for enhanced convenience.

The following specification particularly describes the invention and the manner in which it is to be performed:

### DESCRIPTION OF THE INVENTION

### Technical Field of the Invention

The present invention relates to the field of Light Emitting Diode (LED) lighting technology, specifically focusing on an advanced Power over Ethernet (PoE++) LED driver and a five-channel controller assembly. The present invention revolutionizes the way LED lighting fixtures are powered and controlled, offering efficient, space-efficient, and cost-effective solutions.

### BACKGROUND OF THE INVENTION

LED lighting fixtures are widely used for their energy efficiency and longevity. Traditional LED lighting systems often require separate electrical supplies, leading to complex installations. Additionally, outdoor installations of LED lighting systems necessitate expensive weatherproof enclosures. Power over Ethernet (PoE) technology has emerged as an efficient and cost-effective solution for powering and controlling LED fixtures. Power over Ethernet (PoE++) extends these capabilities, enabling the powering and control of PoE+ devices. Power over Ethernet (PoE++) refers to an advanced technology within the IEEE 802.3bt standard, which enables the simultaneous transmission of data and electrical power over standard ethernet network cables. This technology has been engineered to deliver substantially higher power levels compared to earlier PoE iterations. PoE++ is designed to simplify the deployment and management of various network-connected devices by employing a single ethernet cable for both data communication and power supply. This integration streamlines installation processes, reduces associated costs, and offers enhanced flexibility in device positioning, especially in scenarios where conventional electrical power sources are impractical or expensive to implement.

One of the significant challenges in LED lighting systems is ensuring efficient power management and control. The LED drivers play a pivotal role in regulating the voltage and current supplied to LEDs, maintaining their performance and extending their operational life. Additionally, advancements in LED lighting technology aim to enhance user control, energy efficiency, and integration with other devices or systems.

Power over Ethernet (PoE++) technology, initially developed for data transmission in computer networks, has evolved to power a range of devices, including LED lighting fixtures. PoE++ technology provides both power and data connectivity through standard ethernet cables, simplifying installations, reducing wiring complexity, and enabling remote management. The emerging demand for intelligent, energy-efficient LED lighting systems has driven innovation in PoE-based LED drivers and controllers. These advancements allow for more sophisticated control of lighting parameters, such as intensity, color, and scheduling, while also enabling seamless integration with other networked systems. These systems can enhance user experience, optimize energy consumption, and offer features like circadian rhythm lighting to promote well-being.

Currently, a notable disparity arises in the realm of LED lighting systems. Conventional LED drivers predominantly depend on autonomous electrical power sources, mandating distinct electrical wiring arrangements. This prevailing approach results in elevated intricacies and heightened expenditure during installations.

Furthermore, these existing drivers may lack the requisite efficiency for accommodating diverse fixture types or delivering a comprehensive unified control solution.

For instance, the Patent Application No. WO2023037274A1 titled “Rhythm Lighting System Based On Human Centric Lighting And Spectrum Adjustment Method For Same” discloses a rhythm lighting system based on human centric lighting, comprising: a power module, a time setting assembly, a micro control unit, a light emitting diode (LED) adjustable driving power supply, a first MP LED array, a second MP LED array, a first switch circuit, a second switch circuit, a first current detection circuit, and a second current detection circuit. The rhythm lighting system based on human centric lighting has the advantages of being easy to use and contributing to human health. Time is set by the time setting assembly such as a rotary switch, timing is performed by internal circuits, and two or more LEDs with different MP values are controlled to change the brightness and color temperature, so that light would correspond to spectrums with different MP values within 24 hours a day, and thus people can be helped to adjust the 24-hour natural circadian rhythm of the body. The design facilitates the elderly and people who sleep less to live and rest better and has great economic and use values.

The Patent Application No. US20180054083A1 titled “Supplemental power system for power over ethernet lighting luminaries” discloses a power and control module for a Power over Ethernet (PoE) light emitting diode (LED) lighting system includes an input channel for receiving PoE input power from a PoE switch, an output channel for providing PoE output power to a plurality of LED light fixtures and a power transfer unit coupled between the input and output channel for providing the PoE input power and/or a secondary input power to the output channel as the PoE output power. A secondary power input unit selectively provides secondary power to the power transfer unit. A processor controls the power transfer unit to adjust an amount of PoE input power and secondary input power to obtain the PoE output power. Secondary input power can be an emergency power source during line power outages. Secondary input power could be a renewable energy power source used preferentially to the PoE input power when available.

The patent application Ser. No. 11/522,728B2 Titled “PoE System for the distribution of high voltage power” discloses a system comprising PoE apparatus including midspans, switches and routers that can provide high powered PoE connections that enable the recovery of DC power in sufficient quantities that allow it to be converted to AC power by way of an inverter. The invention also provides a method for providing AC power, data and light to office workstations using a single PoE connection. The invention further comprises a common mode signaling system that operates independently of any TCP/IP signal transmitted through an Ethernet connection wherein said signaling system is adapted to communicate with and control PoE powered devices. As a result, there is a requirement for PoE++ technology that mitigates the challenges by presenting a cohesive solution enabling simultaneous power and data transmission over Ethernet cables. This technology streamlines installation processes, improves energy efficiency, and enables the implementation of advanced control and automation features within the LED lighting sector. Summary of the invention

The present invention addresses the limitations of the prior art by introducing a Power over Ethernet (PoE++) Light Emitting Diode (LED) driver and a five-channel controller assembly designed to revolutionize LED lighting systems. The assembly encompasses a PoE++ input passthrough port that powers and control PoE+ compatible devices, offering up to five output channels. Each channel is configured to provide constant voltage and constant current outputs, allowing for an ethernet-based lighting control system suitable for various lighting applications. The assembly exhibits waterproof and dustproof characteristics and holds an Ingress Protection (IP) rating of IP67 making it ideal for outdoor installation and ensures reliable performance in harsh environmental conditions, even within a temperature range of −40 to +55 degrees Celsius. An integrated power conversion controller within the assembly incorporates protection mechanisms to manage overloading faults, enabling control of various combinations of lighting fixtures.

Moreover, the assembly is distinguished by its compact dimensions, measuring 3 inches in width, 7 inches in length, and 2 inches in height. The assembly seamlessly integrates with advanced home automation systems via custom firmware drivers, simplifying lighting grouping and configuration through connected nodes. The assembly also offers built-in lighting control functions for managing lighting scenes, schedules, and circadian rhythms, thereby enhancing user convenience, comfort, and well-being. Additionally, the assembly supports network-based control, measurement, and monitoring, facilitated by its Internet Protocol (IP) and Media Access Control (MAC) addresses.

The Power over Ethernet (PoE++) LED driver and five-channel controller assembly revolutionizes LED lighting systems. The assembly's key features include PoE++ input passthrough for powering PoE+ devices, versatile channel configurations for constant voltage and constant current output, waterproof and dustproof attributes suitable for outdoor installations, and a compact design for space-efficient use. The assembly seamlessly integrates with advanced home automation systems, offers built-in lighting control functions, and supports network-based control, enhancing user convenience, comfort, and well-being. The present invention addresses the evolving landscape of LED lighting solutions, offering enhanced efficiency, space optimization, and cost-effectiveness in contemporary lighting applications.

### BRIEF DESCRIPTION OF DRAWINGS

FIG. 1 illustrates a block diagram of a Power over Ethernet (PoE++) Light Emitting Diode (LED) driver and a five-channel controller assembly, in accordance with an embodiment of the present invention.

### DETAILED DESCRIPTION OF THE INVENTION

In order to more clearly and concisely describe and point out the subject matter of the claimed invention, the following definitions are provided for specific terms, which are used in the following written description.

The term LED defines a semiconductor device that emits light when an electric current is applied to it. The LED comprises a p-n junction formed within a semiconductor material, with one region doped with electron-rich (n-type) and the other region doped with hole-rich (p-type) materials. When a voltage is applied across the p-n junction, electrons and holes recombine in the semiconductor, releasing energy in the form of photons, which results in the emission of light. The specific wavelength and intensity of the emitted light are determined by the energy bandgap of the semiconductor material and its composition. LEDs are widely used for various applications, including displays, indicators, lighting, and optical communication.

The term five-channel controller is an electronic device configured to manage and coordinate the operation of multiple devices or systems through the manipulation of five distinct communication or control channels. Each of the five channels is capable of transmitting, receiving, or processing signals, data, or instructions, and is designed for the purpose of controlling or regulating separate aspects of one or more interconnected devices or systems. The five-channel controller is typically equipped with interfaces, circuitry, or software that enables it to send, receive, and interpret signals or data from each of the five channels, allowing for the efficient and coordinated control of various functions or parameters across the connected devices or systems.

The present invention encompasses a Power over Ethernet (PoE++) Light Emitting Diode (LED) driver and a five-channel controller assembly. This assembly introduces a pioneering solution for the efficient powering and control of LED lighting fixtures. The Power over Ethernet (PoE++) Light Emitting Diode (LED) driver and a 5-channel controller assembly, adept at delivering constant voltage (12 VDC/24 VDC) and constant current (350 mA/700 mA/1050 mA) outputs for precise control of LED lighting fixtures. The assembly introduces a PoE++(IEEE 802.3bt Class 8) input passthrough port, that enables the provision of power and control to various PoE+ compatible devices, using a single PoE++ LED driver and controller assembly.

The present invention simplifies AC power processing, enhances safety, and provides an efficient and convenient solution for powering and controlling LED lighting fixtures. It paves the way for quicker and more straightforward installations, ultimately reducing overall costs. The assembly is specifically designed for effortless integration with smart home automated systems

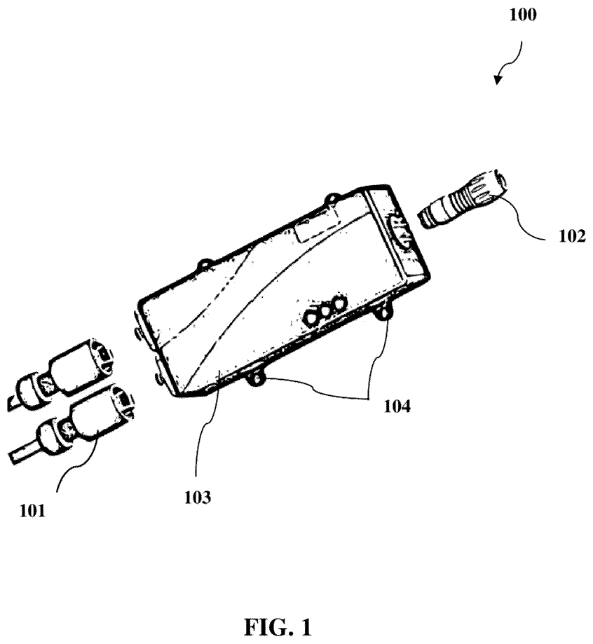

FIG. 1 illustrates a block diagram of a Power over Ethernet (PoE++) Light Emitting Diode (LED) driver and a five-channel controller assembly, in accordance with an embodiment of the present invention. The assembly (100) is equipped with a PoE++ input passthrough port (101), compliant with the IEEE 802.3bt Class 8 standard. The input port (101) serves as a pivotal point for both power supply and control. The input port (101) empowers the assembly (100) to function as a PoE++ LED driver and controller while simultaneously facilitating the powering and control of other PoE+ compatible devices, like cameras and Wi-Fi access points. This duality of purpose distinguishes the assembly (100) from conventional lighting systems.

The assembly (100) further comprises a five-output channel (102) with each channel configurable to offer constant voltage and constant current output, thereby facilitating an ethernet-based lighting control system for a plurality of lighting applications. Further, an integrated power conversion controller (103) with built-in protection mechanisms for managing overloading faults is positioned at the source side of the assembly (100), thereby enabling control of one or more combination of fixtures. Furthermore, the assembly (100) comprises a plurality of waterproof and dustproof attributes (104), culminating in an Ingress Protection (IP) rating, suitable for outdoor installation of the assembly (100), and featuring an operating temperature range of −40 degrees Celsius to +55 degrees Celsius.

The assembly (100) is designed with precision, featuring a compact form factor. Its dimensions are meticulously engineered, measuring approximately 3 inches in width, 7 inches in length, and 2 inches in height. The design maximizes space efficiency and enables seamless integration into various installation scenarios, especially those with spatial constraints. The assembly's (100) operational efficiency surpasses 95%, ensuring optimal energy usage. This energy efficiency contributes to cost-effectiveness and sustainability, making it an ideal choice for various lighting applications. The assembly's (100) engineering is characterized by robust waterproof and dustproof attributes (104). The attributes (104) boasts an Ingress Protection (IP) rating of IP67, signifying its high resistance to both water and dust ingress. This unique feature empowers the assembly (100) to excel in outdoor installations, even in challenging environments where exposure to the elements is a concern. Furthermore, the assembly (100) is designed to operate within an extensive temperature range, spanning from −40 degrees Celsius to +55 degrees Celsius as such operational resilience is well-suited for installations in diverse climatic conditions.

At the core of the assembly's (100) operational functionality resides the power conversion controller (103), meticulously engineered for the efficient and reliable driving of Light Emitting Diodes (LEDs). The power conversion controller (103) is further equipped with an integrated protection system, precision-designed to adeptly manage and mitigate overloading faults originating at the assembly's (100) source side. Each PoE++ LED driver demonstrates an impressive capacity to oversee and regulate a versatile array of fixtures, including but not limited to Red-Green-Blue-White (RGBW) fixtures, color tuning fixtures, and monochromatic fixtures, with the capability to deliver up to 90 Watts of power.

The assembly (100) transcends the realm of standalone lighting solutions and is intricately designed for seamless integration into cutting-edge smart home automated systems. Through the development of meticulously crafted custom firmware drivers, the assembly (100) provides a sophisticated capability to incorporate connected lights into the fabric of smart home systems. This integration not only empowers users but also elevates the user experience, allowing for effortless grouping and fine-tuning of their lighting systems through connected nodes. The integration enhances user convenience and provides an extensive array of customization options, delivering an unprecedented degree of control and personalization within the smart home environment.

The assembly (100) is further enhanced with built-in lighting scene management, scheduling, and circadian rhythm functionality. These set of features grant users the precise control of human-centric lighting, fostering convenience, comfort, and overall well-being. As part of its network capabilities, the assembly (100) possesses both an Internet Protocol (IP) address and a Media Access Control (MAC) address. These addresses enable the assembly (100) to communicate over various network connections. It is designed for network-based control, measurement, and monitoring, enhancing its utility for a wide range of applications. Moreover, the assembly (100) is designed to communicate multiple status and diagnostics/error conditions to a designated host. This feature ensures that the assembly (100) can proactively report its status and detect issues, enhancing the reliability and maintenance of the entire lighting system.

The assembly (100) stands as a holistic embodiment of excellence in LED lighting, seamlessly integrating state-of-the-art power and control functionalities with robust environmental durability, energy-efficient operations, and enhanced user convenience. The assembly's harmonious compatibility with smart home automated systems injects a layer of sophistication into contemporary lighting control, enabling users to experience cutting-edge lighting management. Meanwhile, the assembly's (100) rugged construction and unfaltering safeguarding against environmental elements guarantee steadfast performance, even when subjected to the most challenging conditions. In the landscape of LED lighting systems, the assembly (100) signifies a transformative juncture, ushering in a new era characterized by heightened adaptability and operational efficiency.

The present invention discloses a Power over Ethernet (PoE++) LED driver and 5-channel controller assembly (100) that efficiently powers and controls LED lighting fixtures, further simplifies the installation process and significantly reduces costs by eliminating the need for a separate electrical supply. The assembly's (100) compact design makes it ideal for installations with limited space. The assembly (100) incorporates waterproof and dustproof features, coupled with the IP67 rating, thereby ensuring reliable performance in challenging outdoor environments. By embracing PoE++ technology, the assembly (100) simplifies AC power processing and enhances safety.

The assembly (100) seamlessly integrates with smart home automated systems, providing advanced control and customization options for users, ultimately enhancing convenience and comfort.

### REFERENCE NUMBERS

| Components | Reference Numbers |
|---|---|
| Assembly | 100 |
| PoE++ input passthrough port | 101 |
| Five-output channel | 102 |
| Integrated power conversion controller | 103 |
| Waterproof and dustproof attributes | 104 |

1. A Power over Ethernet (PoE++) Light Emitting Diode (LED) driver and a five-channel controller assembly, the assembly (100) comprises:
a. a PoE++ input passthrough port (101) for powering and controlling one or more PoE+ compatible devices;
b. a five-output channel (102) with each channel configurable to offer constant voltage and constant current output, thereby facilitating an ethernet-based lighting control system for a plurality of lighting applications;
c. an integrated power conversion controller (103) with built-in protection mechanism for managing overloading faults at the source side of the assembly (100), thereby enabling control of one or more combination of fixtures; and
d. a plurality of waterproof and dustproof attributes (104) characterized by a predefined operational temperature range.

2. The assembly (100) as claimed in claim 1, wherein the waterproof and dustproof attributes (104), culminates in an Ingress Protection (IP) rating, suitable for outdoor installation of the assembly (100).

3. The assembly (100) as claimed in claim 1, wherein the assembly (100) is characterized by its compact form factor with dimensions measuring 3 inches in width, 7 inches in length, and 2 inches in height.

4. The assembly (100) as claimed in claim 1, wherein the assembly (100) integrates with advanced home automation systems through one or more custom firmware drivers, using one or more connected nodes.

5. The assembly (100) as claimed in claim 1, wherein the assembly (100) is configured with a plurality of network communication capabilities through an Internet Protocol (IP) address and a Media Access Control (MAC) address, thereby facilitating network-based control, measurement, and monitoring.
